(19) United States
(12) Patent Application Publication
(10) Pub. No.: US 2013/0170486 A1
(43) Pub. Date: Jul. 4, 2013

(54) Network searching method and device for CDMA single-mode chip multi-standby terminal

(71) Applicants: Zhuzhu Wang, Shenzhen (CN); Zitao Xue, Shenzhen (CN); Min Xu, Shenzhen (CN)

(72) Inventors: Zhuzhu Wang, Shenzhen (CN); Zitao Xue, Shenzhen (CN); Min Xu, Shenzhen (CN)

(73) Assignee: ZTE CORPORATION, Shenzhen (CN)

(21) Appl. No.: 13/819,254

(22) PCT Filed: Mar. 3, 2011
(86) PCT No.: PCT/CN2011/071500

§ 371 Date: Feb. 26, 2013

(30) Foreign Application Priority Data
Sep. 1, 2010 (CN) 201010274184.2

(51) Int. Cl. H04W 8/02

(52) U.S. Cl. CPC H04W 8/02
USPC 370/342

(57) ABSTRACT

The present invention discloses a network searching method and device for a CDMA single-mode chip multi-standby terminal. The method comprises: a CDMA single-mode chip multi-standby terminal extracting Preferred Roaming Lists (PRLs) of multiple users who possess the terminal (S102); merging the PRLs of the multiple users who possess the terminal to acquire a union of the PRLs of the multiple users who possess the terminal (S104), and making a network decision for the CDMA single-mode chip multi-standby terminal according to the union of the PRLs of the multiple users who possess the terminal (S106). The terminal performs a union operation on two PRLs and obtains a common PRL as the basis for network search, thus the present invention solves the problem that the CDMA single-mode chip terminal can not implement the network search for multiple users, and further achieves the effect of improving the user experience.

### FIELD OF THE INVENTION

The present invention relates to the field of terminal technologies in the communication industry, and in particular to a network searching method and device for Code Division Multiple Access (CDMA) single-mode chip multi-standby terminal.

### BACKGROUND OF THE INVENTION

In a CDMA2000 1X system, a terminal needs to search a network in accordance with a Preferred Roaming List (PRL). If the terminal can not find an available PRL, the terminal would enter an offline mode; at this moment, the terminal can not initiate any call, comprising an emergency call. Therefore, when a user card or a Non-Volatile memory (NV) of the terminal has no available PRL, the terminal needs to generate a default PRL automatically so as not to enter the offline mode.

The PRL is provided by an operator and has many different versions. Each PRL comprises two parts, namely, Acquisition Records and System Records, each of which comprises many items. Each item in the Acquisition Records comprises the mode, type, frequency band and frequency point of a network capable of providing services. Each item in the System Records comprises information such as system type, Geographical Region Indicate (GEO), priority, Index of corresponding Acquisition Records, System ID (SID)/Network ID (NID) or Mobile Country Code (MCC)/Mobile Network Code (MNC) and the like. The GEO indicates which network bands capable of providing services belong to the same region. Multiple network bands belonging to the same region are different in priority. Respective items with the same GEO in the System Records are divided into a plurality of segments by a mark “MORE” and the priorities of network bands are gradually decreased one segment after another segment from top to bottom.

When searching for a network, the terminal in the CDMA2000 1X system finds a corresponding item in the Acquisition Records, according to a corresponding Index of the Acquisition Records recorded in each item of the System Records in order from top to bottom, acquires a corresponding frequency point and demodulates the frequency point. The terminal first demodulates to obtain a pilot channel and then demodulates to obtain a synchronization channel. At this moment, if the item in the System Records needs the matching of SID/NID (SID=0, NID=65535 representing a wildcard), the terminal performs matching; if the matching succeeds or the matching of SID/NID is not needed, the terminal continues to demodulate to obtain a paging channel and then performs the matching of MCC/MNC; if the matching succeeds, the network capable of providing services is successfully searched out. If one of the above steps in the demodulation procedure can not be performed normally, a next frequency point in the same item of the Acquisition Records is tried, until all frequency points in the item are tried. If the paging channel is not successfully demodulated out when all the frequency points in the item are tried, the terminal repeats the above steps according to the content of a next item in the System Records, until the paging channel is successfully demodulated out and the network is successfully searched out.

A Most Recently Used frequency (MRU) table is a mechanism enabling a terminal to record information of network frequency points most recently used to provide services for the terminal. The table records 10 pieces of information of the networks which provide services most recently. Each piece of the information comprises the mode, type, frequency band and specific frequency point information of a network of which the pilot, synchronization and paging channel can be successfully demodulated out. The information is sorted in a reverse chronological order, and the information of the last used network is in the first place. When reselecting a more optimal network, the terminal needs to write information of the current network into the MRU table. When the terminal is turned off, the MRU table is stored in the NV, for searching for a network next time when the terminal is turned on.

So far, there has not developed a mature solution for CDMA dual-standby network search. Since all present CDMA cell phones search for a network in accordance with a PRL, the implementation of dual-card dual-standby needs to search for a network according to respective PRLs of two users. According to a present CDMA protocol, it is limited that two users each have one PRL, and most cell phones need to adopt a mode of CDMA double-chip to implement the CDMA dual-standby network search. At present, the CDMA dual-standby network search can only be implemented by scheduling two CDMA chips.

The related art has a problem that a CDMA single-mode chip terminal can not implement the network search for multiple users.

### SUMMARY OF THE INVENTION

The present invention provides a network searching method and device for a CDMA single-mode chip multi-standby terminal, which solve the above problem that a CDMA single-mode chip terminal can not implement network search scheduling for multiple users.

According to one aspect of the present invention, a network searching method for a CDMA single-mode chip multi-standby terminal is provided, which comprises: the CDMA single-mode chip multi-standby terminal extracting PRLs of multiple users who possess the terminal; merging the PRLs of the multiple users who possess the terminal to acquire a union of the PRLs of the multiple users who possess the terminal; and making a network decision for the CDMA single-mode chip multi-standby terminal according to the union of the PRLs of the multiple users who possess the terminal.

Preferably, in the technical solution, the CDMA single-mode chip multi-standby comprises two users; the step of merging the PRLs of the multiple users who possess the terminal to acquire the union of the PRLs of the multiple users who possess the terminal comprises: if contents of the PRLs of the two users are the same, taking one of the PRLs of the two users as the union; if contents of the PRLs of the two users have a containing or contained relationship therebetween, taking the PRL with a greater range of the PRLs of the two users as the union; otherwise, subtracting an intersection of the PRLs of the two users from the PRL of one of the two users, adding rest items to the PRL of the other user as the union according to an SID/NID index mode.

Preferably, in the technical solution, one of the two users has a first PRL and the other user has a second PRL; the step of adding the rest items in the first PRL to the second PRL according to the SID/NID index mode comprises: extracting a first SID/NID contained in a first item, to be added to the second PRL, of the first PRL; if the second PRL has an item containing the first SID/NID, adding a frequency point contained in the first item to the item containing the first SID/NID of the second PRL.

Preferably, in the technical solution, if the second PRL has no item containing the first SID/NID, the method further comprises: extracting, from System Records of the first PRL, a second SID/NID contained in a second item which has a same GEO as the first item; if the second PRL has a third item containing the second SID/NID, adding all contents contained in the first item to the second PRL, and keeping a priority relationship between the first item and the third item in the second PRL added with the item to be the same as a priority relationship between the first item and the second item in the original first PRL; otherwise, adding all contents contained in the first item to the end of the second PRL.

Preferably, in the technical solution, after acquiring the union of the PRLs of the multiple users who possess the terminal, the method further comprises: storing the union of the PRLs of the multiple users to a NV of the terminal; when the CDMA single-mode chip multi-standby terminal is restarted after shutdown, if the multiple users have no change, the CDMA single-mode chip multi-standby terminal acquiring the union of the PRLs of the multiple users from the NV of the terminal, demodulating frequency points in the union one by one according to a priority order and searching for a network.

According to one aspect of the present invention, a network searching device for a CDMA single-mode chip multi-standby terminal is provided, and the network searching device is located at the CDMA single-mode chip multi-standby terminal and comprises: an extraction module, a merging module and a network decision module, wherein the extraction module is configured to extract PRLs of multiple users who possess the CDMA single-mode chip multi-standby terminal; the merging module is configured to merge the PRLs of the multiple users who possess the terminal to acquire a union of the PRLs of the multiple users who possess the terminal; and the network decision module is configured to make a network decision for the CDMA single-mode chip multi-standby terminal according to the union of the PRLs of the multiple users who possess the terminal.

Preferably, the CDMA single-mode chip multi-standby comprises two users; the merging module comprises: a sameness sub-module, configured to take one of the PRLs of the two users as the union, if contents of the PRLs of the two users are the same; a containing sub-module, configured to take the PRL with a greater range of the PRLs of the two users as the union, if contents of the PRLs of the two users have a containing or contained relationship therebetween; and an intersection sub-module, configured to subtract an intersection of the PRLs of the two users from the PRL of one of the two users and add rest items to the PRL of the other user as the union according to an SID/NID index mode, if above conditions are not satisfied.

Preferably, for a user A having a first PRL and a user B having a second PRL, the intersection sub-module comprises: an extraction unit, configured to extract a first SID/NID contained in a first item, to be added to the second PRL, of the first PRL; and a direct addition unit, configured to: if the second PRL has an item containing the first SID/NID, add a frequency point contained in the first item to the item containing the first SID/NID of the second PRL.

Preferably, if the second PRL has no item containing the first SID/NID, the intersection sub-module further comprises a priority unit, wherein the extraction unit is further configured to extract, from System Records of the first PRL, a second SID/NID contained in a second item which has a same GEO as the first item; the priority unit is configured to: if the second PRL has a third item containing the second SID/NID, add all contents contained in the first item to the second PRL and keep a priority relationship between the first item and the third item in the second PRL added with the item to be the same as a priority relationship between the first item and the second item in the original first PRL; otherwise, add all contents contained in the first item to the end of the second PRL.

By virtue of the present invention, the terminal performs a union operation on two PRLs and obtains a common PRL as the basis for network search, thereby solving the problem that the CDMA single-mode chip terminal can not implement the network search for multiple users, and further achieving the effect of improving the user experience.

### BRIEF DESCRIPTION OF THE DRAWINGS

Drawings, provided for further understanding of the present invention and forming a part of the specification, are used to explain the present invention together with embodiments of the present invention rather than to limit the present invention, wherein:

FIG. 1 shows a flowchart of a network searching method for a CDMA single-mode chip multi-standby terminal according to Embodiment 1 of the present invention;

FIG. 2 shows a processing flowchart of the condition in which PRLs are different in a network searching method for a CDMA single-mode chip multi-standby terminal according to Embodiment 3 of the present invention; and

FIG. 3 shows a diagram of a network searching device for a CDMA single-mode chip multi-standby terminal according to Embodiment 5 of the present invention.

### DETAILED DESCRIPTION OF EMBODIMENTS

The present invention is described below in detail by reference to the accompanying drawings in conjunction with the embodiments. It should be noted that the embodiments in the application and the characteristics of the embodiments can be combined if no conflict is caused. Specific embodiments of the present invention are illustrated below in detail in conjunction with the accompanying drawings.

### Embodiment 1

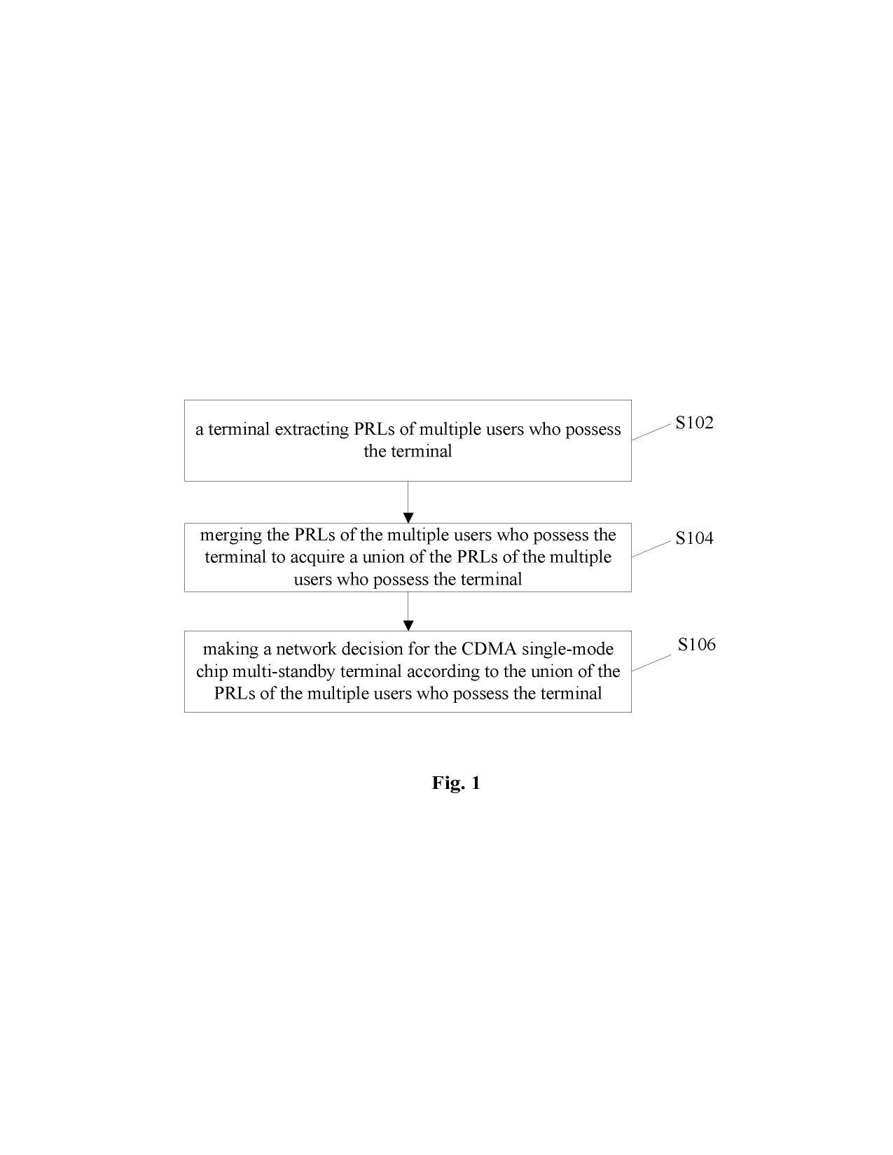

FIG. 1 shows a flowchart of a network searching method for a CDMA single-mode chip multi-standby terminal according to Embodiment 1 of the present invention. As shown in FIG. 1, the method of this embodiment comprises the following steps:

Step 102: a terminal extracts PRLs of multiple users who possess the terminal;

Step 104: the PRLs of the multiple users who possess the terminal are merged to acquire a union of the PRLs of the multiple users who possess the terminal; and

Step 106: a network decision is made for the CDMA single-mode chip multi-standby terminal according to the union of the PRLs of the multiple users who possess the terminal

In this embodiment, a reasonable PRL is obtained through taking a union of respective PRLs of multiple users as the PRL of a dual-card multi-standby cell phone. Subsequently, according to a network search process regulated in a present CDMA protocol, frequency points in the PRL are demodulated one by one based on a priority order until a network is searched out successfully, a pilot channel, a synchronization channel and a paging channel are demodulated out in turn to finally achieve the simultaneous network search for two users. The method of this embodiment implements the network search of the CDMA single-mode chip multi-standby terminal for multiple users and further achieves the effect of improving the user experience.

### Embodiment 2

When merging the PRLs of the multiple users who possess the terminal, various conditions might appear; this embodiment would give a solution for each condition. This embodiment is illustrated by taking two users for example; the condition of more than two users is similar to the condition of two users, thus the description is not repeated here.

1. If the two users use the same PRL, the dual-standby terminal uses this PRL too.

2. If the PRL of one user totally contains contents of the PRL of the other user, the dual-standby terminal uses the PRL with more and comprehensive contents as the basis for network search.

3. In the condition that the PRLs are different, an intersection of the PRLs of the two users is subtracted from the PRL of one of the two users, and rest items are added to the PRL of the other user as a union according to an SID/NID index mode.

This embodiment has all advantages of Embodiment 1 and makes a detailed distinction for each condition, thus this embodiment has higher feasibility

### Embodiment 3

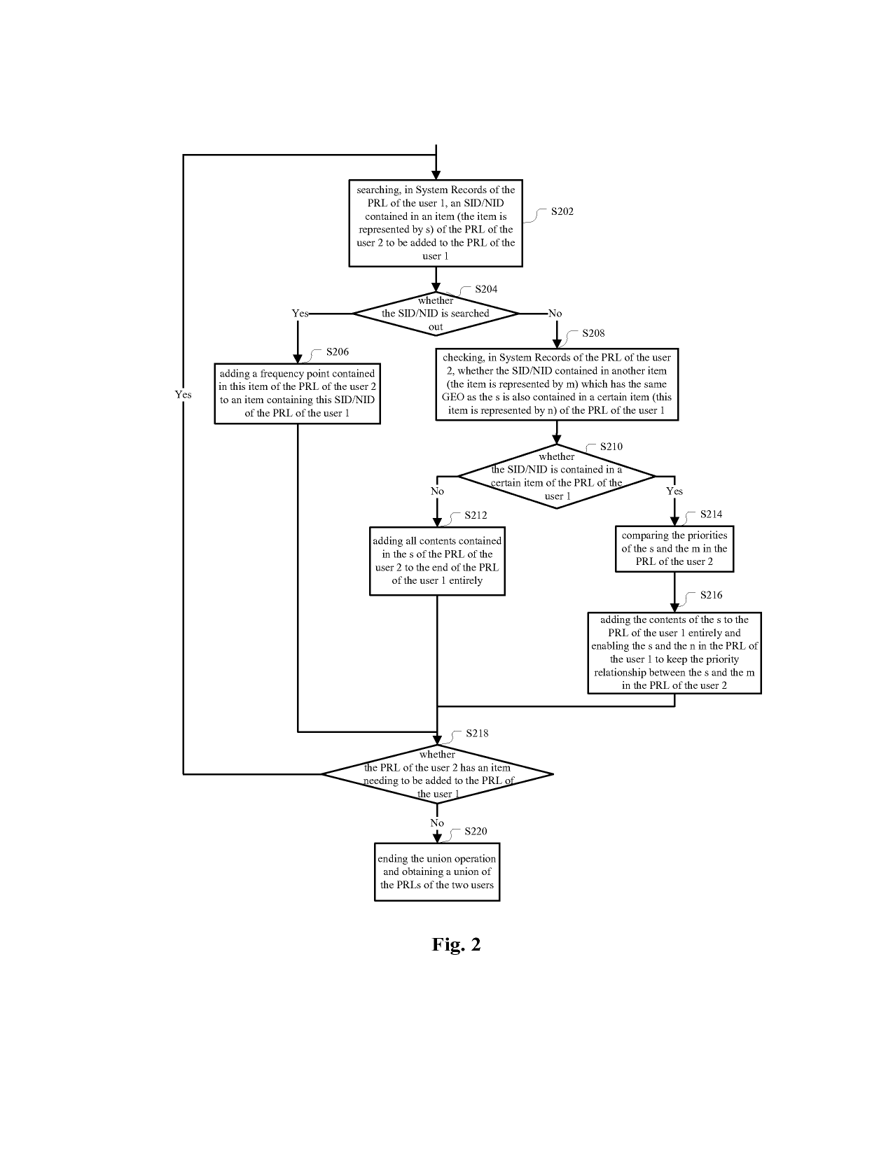

This embodiment illustrates in detail the merging process of the condition in which the PRLs are different in Embodiment 2. FIG. 2 shows a processing flowchart of the condition in which PRLs are different in a network searching method for a CDMA single-mode chip multi-standby terminal according to Embodiment 3 of the present invention. Supposing a terminal has a user 1 and a user 2 and items in the PRL of the user 2 overlapped with the PRL of the user 1 are deleted; as shown in FIG. 2, this embodiment comprises the following steps.

Step 202: search, in System Records of the PRL of the user 1, for an SID/NID contained in an item (the item is represented by s), to be added to the PRL of the user 1, of the PRL of the user 2.

Step 204: whether such an SID/NID is searched out, if so, execute Step 206; otherwise, execute Step 208.

Step 206: a frequency point contained in this item of the PRL of the user 2 is added to an item containing this SID/NID of the PRL of the user 1; execute Step 218.

Step 208: check, in System Records of the PRL of the user 2, whether the SID/NID contained in another item (the item is represented by m) which has the same GEO as the s is also contained in a certain item (this item is represented by n) of the PRL of the user 1.

Step 210: if not, execute Step 212; otherwise, execute Step 214.

Step 212: all contents contained in the s of the PRL of the user 2 are entirely added to the end of the PRL of the user 1; execute Step 218.

Step 214: the priorities of the s and the m in the PRL of the user 2 are compared.

Step 216: the contents of the s are entirely added to the PRL of the user 1, and the priority relationship between the s and the n in the PRL of the user 1 is kept the same as the priority relationship between the s and the m in the PRL of the user 2; execute Step 218.

Step 218: whether the PRL of the user 2 has an item needing to be added to the PRL of the user 1, if so, execute Step 202; otherwise, execute Step 220.

Step 220: the union operation is completed and a union of the PRLs of the two users is obtained.

Specifically, in this embodiment, the union operation is performed based on the SID/NID contained in the item of the PRL and adds unique items of one PRL to the other PRL. For two items with the same SID/NID, frequency points contained in the two items are directly merged; for two items with different SIDs/NIDs, an original priority relationship between the two items in the same GEO should be kept and all contents of one item is completely added to the other item; for the items with no priority relationship therebetween, the items are directly added to the end of the PRL.

In this embodiment, the union of the PRLs of the two users obtained according to the method of this embodiment is stored to an NV of the terminal. After restarted, the terminal directly uses the PRL union stored in the NV of the terminal as the basis for network search, only if a user card does not change. If the user card changes, after restarted, the terminal needs to perform a union operation on the PRLs of two new users to obtain a new PRL union as the basis for the network search of the dual-standby terminal. For the dual-standby terminal, it still adopts the MRU table mechanism to improve the network search efficiency when started, only the MRU table records information of 10 network frequency points most recently used by the two users.

This embodiment describes in detail the implementation for merging the PRLs of two users according to the mode of SID/NID index and implements the network search for two users, with all advantages of the embodiments above, thus the description is not repeated here.

### Embodiment 4

This embodiment describes an entire network searching method for a CDMA single-mode chip multi-standby terminal. This embodiment is described by taking two CDMA set-card separated numbers for example; supposing the International Mobile Subscriber Identity (IMSI) of a user 1 is x and the PRL of the user 1 is a, the IMSI of a user 2 is y and the PRL of the user 2 is b. This embodiment mainly comprises the following steps.

1) After being started and initialized, the terminal acquires the IMSI, the PRL and other data of the user 1, meanwhile acquires the IMSI, the PRL and other data of the user 2.

2) According to a Preferred Roaming List ID in the PRL, judge the versions of the PRLs of the two users, wherein the versions of the two PRLs might be the same or different.

3) In the condition that the versions of the PRLs of the two users are the same (generally, the contents of the same version of PRLs of one operator are the same), one PRL is used to search for a network. However, the PRLs might be of the same version but different contents, at this moment, the PRLs of the two users need to be subjected to a union operation and the union is taken as the PRL of the dual-card dual-standby terminal for searching for a network; for a specific method for calculating the union, go to 5).

4) In the condition that the versions of the PRLs of the two users are different, the new version of PRL probably completely contains the contents of the old version of PRL, at this moment, the terminal takes the new version of PRL as the PRL of the dual-card dual-standby terminal for searching for a network. However, the new version of PRL probably does not completely contain the contents of the old version of PRL, at this moment, an intersection of the contents of the new version of PRL and the old version of PRL needs to be subtracted from the old version of PRL, and the items remained in the old version of PRL are added to the new version of PRL, so that a union of the PRLs of the two users is obtained; for a specific method for calculating the union, go to 6).

5) The two PRLs are of the same version but different contents, an intersection of the PRLs of the two users is subtracted from one PRL a, the items remained in the PRL a are added to the other PRL b; for a specific method for the addition, go to 7).

6) The new version of PRL does not completely contain the content of the old version of PRL, items existing only in the old version of PRL but in the new version of PRL are added to the new version of PRL b; for a specific method for the addition, go to 7).

7) Calculation of the union of the two PRLs: whether an SID/NID contained in an item (the item is represented by s), to be added to the PRL of the user 1, of the PRL of the user 2 exists in System Records of the PRL of the user 1, if so, a frequency point contained in this item of the PRL of the user 2 is added to an item containing this SID/NID of the PRL of the user 1; otherwise, go to 8).

8) Check, in System Records of the PRL of the user 2, whether the SID/NID contained in another item (the item is represented by m) which has the same GEO as the s is the same as the SID/NID contained in a certain item (this item is represented by n) of the PRL of the user 1, if so, go to 9); otherwise, all contents contained in the s of the PRL of the user 2 are entirely added to the end of the PRL of the user 1.

9) The priorities of the s and the m in the PRL of the user 2 are compared; the contents of the s are entirely added to the PRL of the user 1 and the priority relationship between the s and the n in the PRL of the user 1 is kept the same as the priority relationship between the s and the m in the PRL of the user 2.

10) Whether the PRL of the user 2 has an item needing to be added to the PRL of the user 1, if so, repeat 7) to 9); otherwise, the union operation is completed, a union of the PRLs of the two users is obtained and stored to an NV.

11) During the usage process, every time when reselecting a more optimal network, the terminal records information of a network frequency point currently used into an MRU table, wherein the table records information of 10 network frequency points which have provided services successfully most recently; when the terminal is turned off, the MRU table is stored to the NV of the terminal, to be used by the terminal next time when turned on.

12) When turned on next time, the terminal compares whether a newly acquired IMSI x or y is different from the IMSI stored last time when the terminal is turned on, if so, repeats 2) to 10) to perform a union operation on the PRLs of the two new users; otherwise, directly adopts the MRU table or PRL union stored in the NV.

13) According to the calculated PRL union, each frequency point is demodulated in turn from highest to lowest priority; only if a pilot channel, then a synchronization channel and finally a paging channel can be demodulated out based on a certain frequency point, the network is successfully searched out, and no demodulation is performed for the following frequency points.

The specific implementation of this embodiment can be referred to the related description in Embodiments 1 to 3 and has all advantages of the embodiments above. Moreover, the method of this embodiment has characteristics of: 1. reducing the cost of CDMA dual-standby and quickly implementing dual-card dual-standby network search based on a current chip; 2. implementing simultaneous network search for two users on the basis of guaranteeing efficiency and stability of the network search; 3. being applicable to different CDMA1x environments; 4. being applicable to various conditions and processes of network search.

### Embodiment 5

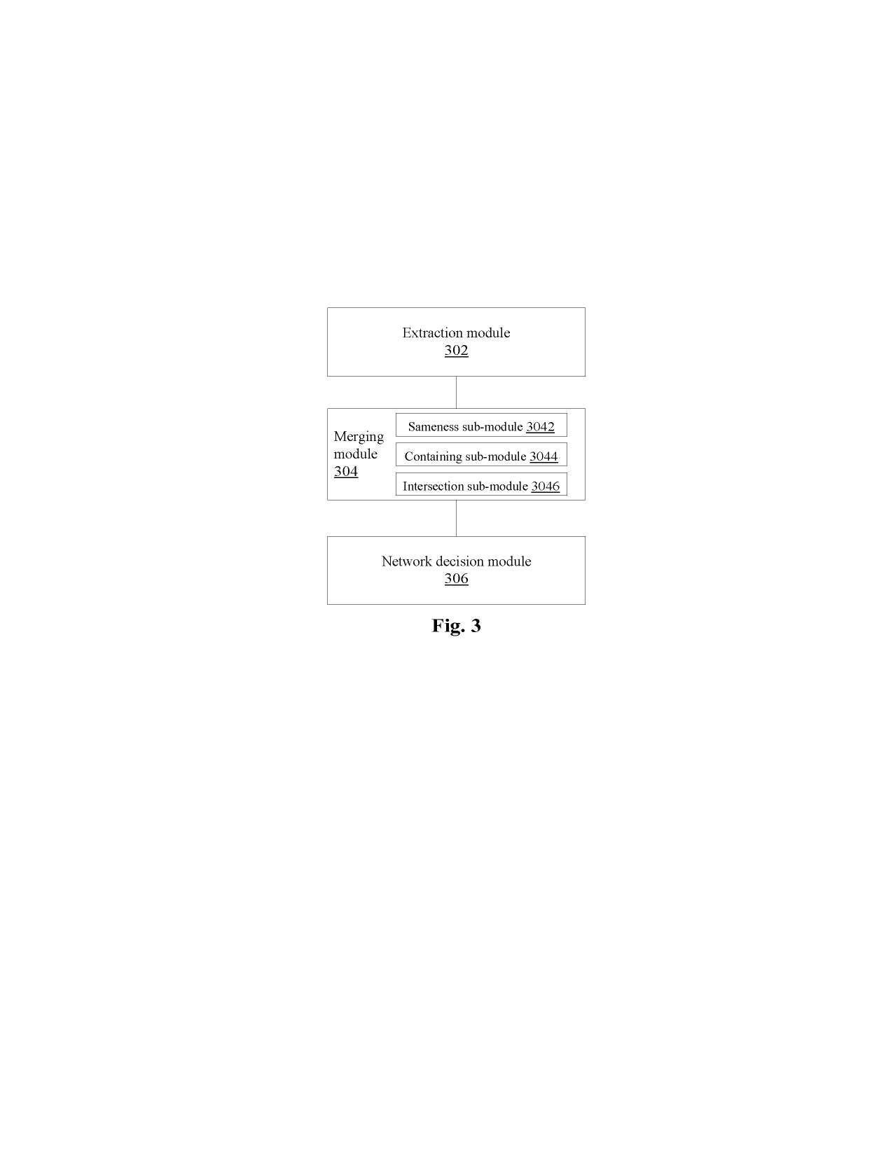

FIG. 3 shows a diagram of a network searching device for a CDMA single-mode chip multi-standby terminal according to Embodiment 5 of the present invention. As shown in FIG. 3, the network searching device for a CDMA single-mode chip multi-standby terminal disclosed in this embodiment is located at the terminal and comprises: an extraction module 302, a merging module 304 and a network decision module 306, wherein the extraction module 302 is configured to extract PRLs of multiple users who possess the CDMA single-mode chip multi-standby terminal; the merging module 304 is coupled with the extraction module 302 and configured to merge the PRLs of the multiple users who possess the terminal to acquire a union of the PRLs of the multiple users who possess the terminal; and the network decision module 306 is coupled with the merging module 304 and configured to make a network decision for the CDMA single-mode chip multi-standby terminal according to the union of the PRLs of the multiple users who possess the terminal.

The implementation method of this embodiment can be referred to the related description in Embodiment 1 and has all advantages of Embodiment 1, thus the description is not repeated here.

### Embodiment 6

This embodiment is illustrated by taking two users for example. As shown in FIG. 3, in this embodiment, the merging module comprises: a sameness sub-module 3042, configured to take one of the PRLs of the two users as a union, if contents of the PRLs of the two users are the same; a containing sub-module 3044, configured to take the PRL with a greater range of the PRLs of the two users as the union, if contents of the PRLs of the two users have a containing or contained relationship therebetween; and an intersection sub-module 3046, configured to subtract an intersection of the PRLs of the two users from the PRL of one of the two users and add rest items to the PRL of the other user as the union according to an SID/NID index mode, if the above conditions are not satisfied.

For a user A having a PRL_A and a user B having a PRL_B, the intersection sub-module comprises: an extraction unit, configured to extract an SID/NID_a contained in an item PRL_A_a of the PRL_A to be added to the PRL_B; and a direct addition unit, configured to: if the PRL_B has an item containing the SID/NID_a, add a frequency point contained in the item PRL_A_a to the item containing the SID/NID_a of the PRL_B.

If the PRL_B has no item containing the SID/NID_a, the intersection sub-module further comprises a priority unit, wherein the extraction unit is further configured to extract, from System Records of the PRL_A, an SID/NID_b contained in an item PRL_A_b which has the same GEO as the PRL_A_a; the priority unit is configured to: if the PRL_B has an item PRL_B_b containing the SID/NID_b, add all contents contained in the PRL_A_a to the PRL_B and keep the priority relationship between the PRL_A_a and the PRL_B_b in the PRL_B added with the item to be the same as the priority relationship between the PRL_A_a and the PRL_A_b in the original PRL_A; otherwise, add all contents contained in the PRL_A_a to the end of the PRL_B.

The implementation method of this embodiment can be referred to the related description in Embodiments 2 to 4 and has all advantages of the above embodiments, thus the description is not repeated here.

Obviously, those skilled in the art shall understand that the above-mentioned modules and steps of the present invention can be realized by using general purpose calculating device, can be integrated in one calculating device or distributed on a network which consists of a plurality of calculating devices. Alternatively, the modules and the steps of the present invention can be realized by using the executable program code of the calculating device. Consequently, they can be stored in the storing device and executed by the calculating device, or they are made into integrated circuit module respectively, or a plurality of modules or steps thereof are made into one integrated circuit module. In this way, the present invention is not restricted to any particular hardware and software combination.

The descriptions above are only the preferable embodiment of the present invention, which are not used to restrict the present invention. For those skilled in the art, the present invention may have various changes and variations. Any amendments, equivalent substitutions, improvements, etc. within the principle of the present invention are all included in the scope of the protection of the present invention.

1. A network searching method for a Code Division Multiple Access (CDMA) single-mode chip multi-standby terminal, comprising:
the CDMA single-mode chip multi-standby terminal extracting Preferred Roaming Lists (PRLs) of multiple users who possess the terminal;
merging the PRLs of the multiple users who possess the terminal to acquire a union of the PRLs of the multiple users who possess the terminal; and
making a network decision for the CDMA single-mode chip multi-standby terminal according to the union of the PRLs of the multiple users who possess the terminal.

2. The network searching method according to claim 1, wherein the CDMA single-mode chip multi-standby comprises two users; the step of merging the PRLs of the multiple users who possess the terminal to acquire the union of the PRLs of the multiple users who possess the terminal comprises:
if contents of the PRLs of the two users are the same, taking one of the PRLs of the two users as the union;
if contents of the PRLs of the two users have a containing or contained relationship therebetween, taking the PRL with a greater range of the PRLs of the two users as the union;
otherwise, subtracting an intersection of the PRLs of the two users from the PRL of one of the two users, adding rest items to the PRL of the other user as the union according to a System ID (SID)/Network ID (NID) index mode.

3. The network searching method according to claim 2, wherein one of the two users has a first PRL and the other user has a second PRL; the step of adding the rest items in the first PRL to the second PRL according to the SID/NID index mode comprises:
extracting a first SID/NID contained in a first item, to be added to the second PRL, of the first PRL;
if the second PRL has an item containing the first SID/NID, adding a frequency point contained in the first item to the item containing the first SID/NID of the second PRL.

4. The network searching method according to claim 3, wherein if the second PRL has no item containing the first SID/NID, the method further comprises:
extracting, from System Records of the first PRL, a second SID/NID contained in a second item which has a same Geographical Region Indicate (GEO) as the first item;
if the second PRL has a third item containing the second SID/NID, adding all contents contained in the first item to the second PRL, and keeping a priority relationship between the first item and the third item in the second PRL added with the item to be the same as a priority relationship between the first item and the second item in the original first PRL; otherwise, adding all contents contained in the first item to the end of the second PRL.

5. The network searching method according to claim 1, wherein after acquiring the union of the PRLs of the multiple users who possess the terminal, the method further comprises:
storing the union of the PRLs of the multiple users to a Non-Volatile memory (NV) of the terminal;
when the CDMA single-mode chip multi-standby terminal is restarted after shutdown, if the multiple users have no change, the CDMA single-mode chip multi-standby terminal acquiring the union of the PRLs of the multiple users from the NV of the terminal, demodulating frequency points in the union one by one according to a priority order and searching for a network.

6. The network searching method according to claim 5, wherein the CDMA single-mode chip multi-standby terminal searches for the network adopting a Most Recently Used frequency (MRU) table mechanism, wherein an MRU table contains information of ten network frequency points most recently used by the multiple users.

7. A network searching device for a CDMA single-mode chip multi-standby terminal, wherein the network searching device is located at the CDMA single-mode chip multi-standby terminal and comprises: an extraction module, a merging module and a network decision module, wherein
the extraction module is configured to extract PRLs of multiple users who possess the CDMA single-mode chip multi-standby terminal;
the merging module is configured to merge the PRLs of the multiple users who possess the terminal to acquire a union of the PRLs of the multiple users who possess the terminal; and
the network decision module is configured to make a network decision for the CDMA single-mode chip multi-standby terminal according to the union of the PRLs of the multiple users who possess the terminal.

8. The device according to claim 7, wherein the CDMA single-mode chip multi-standby comprises two users; the merging module comprises:
a sameness sub-module, configured to take one of the PRLs of the two users as the union, if contents of the PRLs of the two users are the same;
a containing sub-module, configured to take the PRL with a greater range of the PRLs of the two users as the union, if contents of the PRLs of the two users have a containing or contained relationship therebetween; and
an intersection sub-module, configured to subtract an intersection of the PRLs of the two users from the PRL of one of the two users and add rest items to the PRL of the other user as the union according to an SID/NID index mode, if above conditions are not satisfied.

9. The device according to claim 8, wherein for a user A having a first PRL and a user B having a second PRL, the intersection sub-module comprises:
an extraction unit, configured to extract a first SID/NID contained in a first item, to be added to the second PRL, of the first PRL; and
a direct addition unit, configured to: if the second PRL has an item containing the first SID/NID, add a frequency point contained in the first item to the item containing the first SID/NID of the second PRL.

10. The device according to claim 9, wherein if the second PRL has no item containing the first SID/NID, the intersection sub-module further comprises a priority unit, wherein
the extraction unit is further configured to extract, from System Records of the first PRL, a second SID/NID contained in a second item which has a same GEO as the first item;
the priority unit is configured to: if the second PRL has a third item containing the second SID/NID, add all contents contained in the first item to the second PRL and keep a priority relationship between the first item and the third item in the second PRL added with the item to be the same as a priority relationship between the first item and the second item in the original first PRL; otherwise, add all contents contained in the first item to the end of the second PRL.

11. The network searching method according to claim 2, wherein after acquiring the union of the PRLs of the multiple users who possess the terminal, the method further comprises:
storing the union of the PRLs of the multiple users to a Non-Volatile memory (NV) of the terminal;
when the CDMA single-mode chip multi-standby terminal is restarted after shutdown, if the multiple users have no change, the CDMA single-mode chip multi-standby terminal acquiring the union of the PRLs of the multiple users from the NV of the terminal, demodulating frequency points in the union one by one according to a priority order and searching for a network.

12. The network searching method according to claim 3, wherein after acquiring the union of the PRLs of the multiple users who possess the terminal, the method further comprises:
storing the union of the PRLs of the multiple users to a Non-Volatile memory (NV) of the terminal;
when the CDMA single-mode chip multi-standby terminal is restarted after shutdown, if the multiple users have no change, the CDMA single-mode chip multi-standby terminal acquiring the union of the PRLs of the multiple users from the NV of the terminal, demodulating frequency points in the union one by one according to a priority order and searching for a network.

13. The network searching method according to claim 4, wherein after acquiring the union of the PRLs of the multiple users who possess the terminal, the method further comprises:
storing the union of the PRLs of the multiple users to a Non-Volatile memory (NV) of the terminal;
when the CDMA single-mode chip multi-standby terminal is restarted after shutdown, if the multiple users have no change, the CDMA single-mode chip multi-standby terminal acquiring the union of the PRLs of the multiple users from the NV of the terminal, demodulating frequency points in the union one by one according to a priority order and searching for a network.

14. The network searching method according to claim 11, wherein the CDMA single-mode chip multi-standby terminal searches for the network adopting a Most Recently Used frequency (MRU) table mechanism, wherein an MRU table contains information of ten network frequency points most recently used by the multiple users.

15. The network searching method according to claim 12, wherein the CDMA single-mode chip multi-standby terminal searches for the network adopting a Most Recently Used frequency (MRU) table mechanism, wherein an MRU table contains information of ten network frequency points most recently used by the multiple users.

16. The network searching method according to claim 13, wherein the CDMA single-mode chip multi-standby terminal searches for the network adopting a Most Recently Used frequency (MRU) table mechanism, wherein an MRU table contains information of ten network frequency points most recently used by the multiple users.
